(19) United States
(12) Patent Application Publication
(10) Pub. No.: US 2014/0320990 A1
(43) Pub. Date: Oct. 30, 2014

(54) SOLAR CONCENTRATOR INCLUDING A HELIOSTAT AND A FRESNEL LENS

(71) Applicants: Joel Gilbert, Eguilles (FR); Ludovic Deblois, Puyricard (FR)

(72) Inventors: Joel Gilbert, Eguilles (FR); Ludovic Deblois, Puyricard (FR)

(73) Assignee: SUNPARTNER, Lambesc (FR)

(21) Appl. No.: 13/520,672

(22) PCT Filed: Jun. 25, 2012
(86) PCT No.: PCT/FR12/00256

§ 371 Date: Jul. 21, 2014

(30) Foreign Application Priority Data
Jun. 27, 2011 (FR) 11/01971

(51) Int. Cl. G02B 7/183

(52) U.S. Cl. CPC G02B 7/183
USPC 359/853

(57) ABSTRACT

An heliostat includes a plane mirror and a first axis of rotation which is positioned parallel to the axis of rotation of the Earth. The solar radiation reflected by the mirror is permanently oriented toward a stationary Fresnel lens which is perpendicular to the first axis of rotation and which concentrates the solar radiation toward a stationary target. A solar field is composed of a plurality of heliostats according to such characteristics and all the first axes of rotation of which are rotated by a mechanical linkage coupled to a rod which is moved by a single motor. This arrangement reduces the total cost of the installation.

The present invention relates to solar concentrators and more particularly those the target of which is stationary, like the ones using heliostats for concentrating the light of the sun onto a target fixed at the top of a tower, with such target being a thermal sensor for the production of mechanical or heat energy, and/or a photovoltaic sensor for the production of electric energy.

### STATE OF THE ART

The operating principle of solar concentrators using heliostats is that each heliostat re-directs the solar radiation toward a stationary target, which causes an accumulation of light at the surface of the target, and thus a concentration of the radiation which is proportional to the number of heliostats. As the sun moves in two directions, height- and azimuth-wise, heliostats generally have two axes of rotation to follow the sun, thus two motors each, which is expensive and increases the needs for maintenance.

Some particular devices are already known ((U.S. 2006060188 A1 ; U.S. Pat. No. 7,192,146 A1; U.S. Pat. No. 5,787,878 A1) which make it possible to rotate, with a single motor, a plurality of heliostats, which reduces the number of motors and thus the total cost of an installation. However, the mechanical part of heliostats is still complex and expensive.

### CLAIM OF THE INVENTION

The main aim of the invention is thus to improve solar concentrators and to provide a structure making it possible to remedy the above-mentioned drawbacks relating to complexity and costs. More particularly, the present invention aims at enabling high solar concentrations with a single heliostat and a target which will remain stationary.

Another aim of the invention is to provide a solar concentrator wherein each heliostat will have simplified rotation mechanics, which will require a reduced number of motors, and thus entail savings on the total cost of the installation.

### SUMMARY OF THE INVENTION

The basic device which is the object of the invention includes an heliostat, the mirror of which is plane. The mirror is rotated about two axes, of which a first axis is parallel to the axis of rotation of the Earth and thus oriented toward the pole star, and a second axis which is perpendicular and attached to the first one. A Fresnel lens is positioned running on from the first axis of rotation, with a surface perpendicular to this first axis of rotation and positioned so that this axis crosses the centre of the lens. A target is placed at the focal distance of the Fresnel lens. The target is a photovoltaic cell and/or a thermal sensor and/or a thermal motor or a Stirling motor, or even a chemical reaction sensor like a hydrogen catalyst. The heliostat thus contains a plane mirror and a first axis of rotation parallel to the axis of rotation of the Earth, and a second axis of rotation which is perpendicular to the first axis of rotation. The Fresnel lens is stationary, the focal distance thereof is linear or punctual and the perpendicular to the centre of its surface is aligned with the first axis of rotation. The target can be placed between the Fresnel lens and the focal plane thereof, but it is preferably positioned at the focal distance of the lens.

Parallel sunbeams are reflected by the mirror on the heliostat toward the Fresnel lens which concentrates these onto the target. The mirror rotates about its first axis of rotation to follow the sun in its clockwise displacement. Thus, it rotates by one turn in 24 hours. The mirror rotates about its second axis of rotation to follow the sun in its yearly displacement. It pivots by 12 degrees about a reference position, which is that of the equinox. Such reference position places the perpendicular to the mirror at 45° with respect to the sunbeams. On the summer solstice, the perpendicular to the mirror is at 45°+12°=57° with respect to the sunbeams, whereas on the winter solstice, the perpendicular to the mirror is at 45°−12°=33° with respect to the sunbeams. As the rotation of both axes is slow, it can occur by time-delayed increments, for instance 0.25 degrees every minute as regards the first axis and approximately 0.9 degrees every week as regards the second axis. The rotation about the first axis can be executed by the mechanical coupling to a motor. The rotation about the second axis can be executed either by the mechanical coupling to a motor, or by a manual operation. The electric control of the motors is either wired or remote-controlled and wireless.

In a particular embodiment, the Fresnel lens is divided into a plurality of Fresnel lens, the shapes, sizes and focal distances of which are preferably identical. Such Fresnel lens concentrate the solar radiation onto a plurality of targets positioned between the lens and the focal planes thereof.

In a particular embodiment of a solar field integrating a plurality of concentrators, several concentrators similar to those described above, are aligned on the ground, so that all the first axes are parallel together and include a mechanical part of the pulley or sprocket wheel or endless screw types, with all said mechanical parts being mechanically coupled to a connection rod, more particularly a rectilinear rod connecting all such mechanical parts together, so that the rotation of all the first axes of all the concentrators is simultaneously caused by a single motor acting on the connection rod.

Such plurality of solar concentrators thus build a solar field, for which the first axes of rotation of the mirrors are parallel together and are all mechanically connected together by means of a connection rod, the motion of which simultaneously rotates said first axes of rotation.

### DETAILED DESCRIPTION OF THE INVENTION

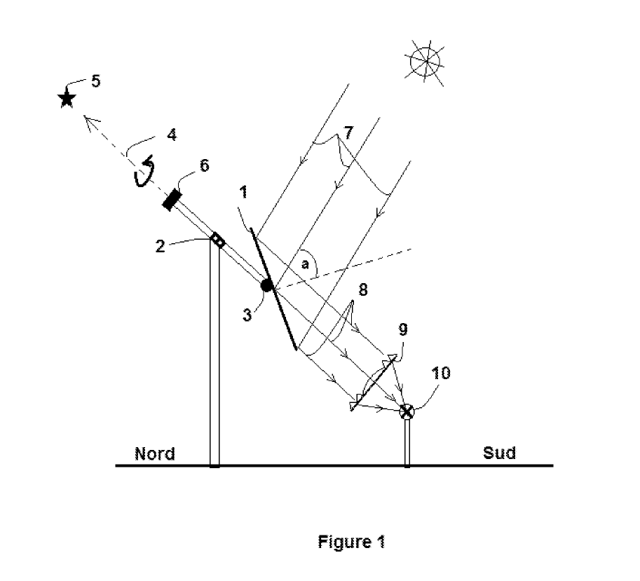

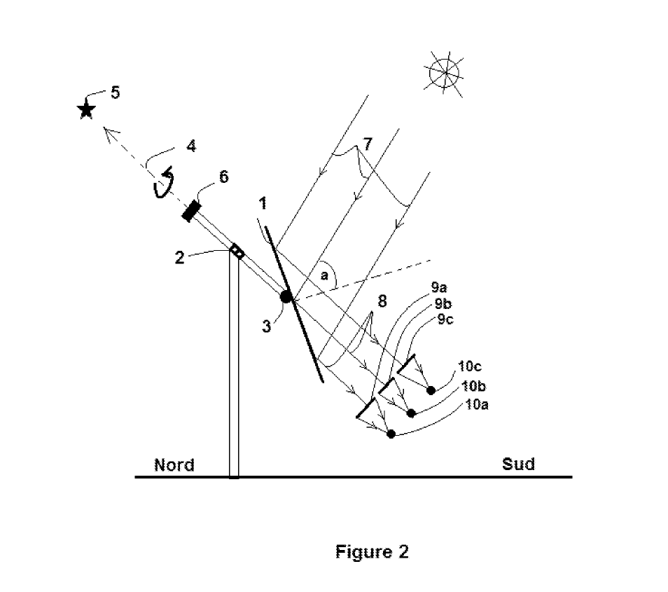

The invention will now be described in greater details with the appended FIGS. 1 and 2.

FIG. 1 is a schematic diagram of the solar concentrator on a cross-sectional elevation view.

FIG. 2 shows a particular embodiment wherein the concentrator includes three Fresnel lens and three identical targets.

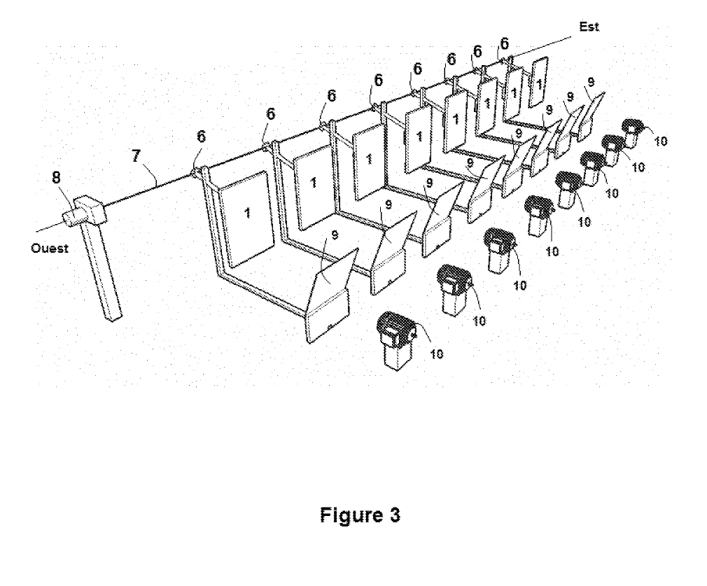

FIG. 3 illustrates a particular embodiment wherein several solar concentrators are controlled by a single motor.

The solar concentrator in FIG. 1 receives parallel sunbeams 7 on a plane mirror 1. The mirror 1 can rotate about a first axis of rotation 4 which is parallel to the axis of rotation of the Earth, and is thus directed toward the pole star 5. The mirror 1 can rotate around a second axis of rotation 3 which is perpendicular to the first axis of rotation 4. The reflected sunbeams 8 are directed toward a stationary Fresnel lens 9 which concentrates the radiation toward a target 10 which is positioned between the lens 9 and the focal plane thereof. The Fresnel lens 9 has a linear or punctual focal distance, with the line perpendicular to the lens crossing its centre runs on from the first axis of rotation 4 of the mirror 1.

The target 10 is a photovoltaic cell and/or a thermal sensor and/or a thermal motor or a Stirling motor, or even a chemical reaction sensor like a hydrogen catalyst. In the North hemisphere, the mirror 1 is preferably positioned northward and the Fresnel lens 9 southward. In the South hemisphere (a particular position which is not shown), the mirror is preferably positioned southward and the Fresnel lens northward. The rotation of the mirror 1 about the first axis of rotation 4 makes it possible to follow the sun motion clockwise, i.e. a rotation in 24 hrs. The rotation of the mirror 1 about the second axis of rotation 3 makes it possible to follow the yearly motion of the sun, i;e. a maximum deviation (a) of 12 degrees northward (on the summer solstice) and 12 degrees southward (on the winter solstice), from a reference position corresponding to the summer or winter equinoxes, when the line perpendicular to the mirror 1 makes an angle (a) of 45 degrees with the solar radiation 7. On the summer solstices, the perpendicular to the mirror 1 thus makes an angle of 45°+12°=57° with respect to the sunbeams 7, whereas on the winter solstices, the perpendicular to the mirror makes an angle of 45°−12°=33° with respect to the sunbeams 7.

The rotation of the first axis 4 can be obtained through the coupling of a motor 2 with a wire electric control or a remote-controlled motor. The rotation of the second axis 3 can be manually obtained by multiple repeated angular corrections, which corresponds to an average weekly correction of 0.9 degrees. The second axis can also be controlled by a motor with a wire electric control or a remote-controlled motor (not shown).

FIG. 2 shows a particular embodiment wherein the Fresnel lens 9 of the basic model (FIG. 1) is divided into three Fresnel lens 9a, 9b, 9c. In this non limiting example, the Fresnel lens have identical shapes, sizes and focal lengths. Such Fresnel lens 9a, 9b, 9c concentrate the solar radiation 8 respectively on targets 10a, 10b, 10c preferably positioned at the focal plane of each lens.

FIG. 3 illustrates the possibility of aligning with an East/West axis a plurality of solar concentrators according to the invention, which can be called a solar field, so that all the first axes of rotation are parallel together and are all connected by a connection rod 7 or a threaded rod, through a mechanical part 6 which can be, for instance, a pulley, a sprocket wheel or an endless screw. The motion or rotation of the rod 7 further to the action of a single motor 8 then makes it possible to rotate all the first axes of rotation and thus mirrors 1. In the solar field, the Fresnel lens 9 and the targets 10 remain stationary.

A concrete exemplary embodiment of the solar concentrator according to the invention will now be described. A solar field located at a latitude of 42° North is composed, in the present example, of 10 heliostats aligned along the East/West direction, and include 1 m×1.50 m rectangular mirrors 1. The mirrors 1 are fixed, at their back, to a first axis of rotation 4 which is directed toward the pole star 5, and thus directed North/South and inclined by 42° with respect to the North horizon. A second axis of rotation 3 is perpendicular to the first axis 4 and inclines the mirrors by 45° with respect to the sunbeams on March 21st, or September 21st. A concentric Fresnel lens 9 made of organic glass is square-shaped with a side measuring 1 m. It faces the sunbeams reflected 8 by the mirror so that the perpendicular to the centre of its surface runs on from the first axis of rotation 4 of the mirror. The focal distance of the lens is equal to 1.20 m. The thermal sensor of a Stirling motor 10, with a power of 250 Watts, is positioned at the focal distance of the lens 9. The end of the first axis of rotation 4 is provided with a sprocket, 30 cm in diameter. The ten sprocket wheels 6 of the ten heliostats are connected by a threaded rod 7, 15 mm in diameter. The rotation of the 7 is obtained by a rotating electric motor 8 positioned at one of the ends of the rod 7. This rotation rotates each mirror by one turn in 24 hours. The second axis of rotation (3) of each mirror is rotated by a remote-controlled step-by-step electric motor fixed on the rear of the mirror. The motion of the second axis of rotation 3 is programmed by a remote astronomical calculator which orientates the mirrors according to the declination of sun with respect to the celestial equator. This motion is very reliable and corresponds to an average of 0.9 degrees per week. The remote-controlled motor is power supplied by a battery or a super-capacitor housed at the back of the mirror. The battery or the super-capacitor are charged using a 1 Watt photovoltaic cell connected to one end of the mirror and permanently lit by the sun. When the sky is clear, the solar power amounts to approximately 1,000 W per m² of surface. The heliostats send back to the Fresnel lens 9 the power which is concentrated on the thermal sensor 10 of the Stirling motor. As the output of the motor amounts to 25%, the mechanical yield of the motor amounts to 250 Watts. Such mechanical power is transformed into electricity using a dynamo coupled to each motor. The total power supplied by the solar field then amounts to 2,500 Watts.

### ADVANTAGES OF THE INVENTION

The invention thus reaches the required aims. It is more particularly adapted to high solar concentration with a target which remains stationary and a reduced number of motors for rotating the heliostats. Such simplification of the mechanical part required for following the sun thus reduced the total costs of the installation.

1. A solar concentrator comprising:
a heliostat having a mirror which is plane, a first axis of rotation which is parallel to the axis of rotation of the Earth, and a second axis of rotation which is perpendicular to the first axis of rotation,
a stationary Fresnel lens having a focal distance of which is linear or punctual and the perpendicular of which in the centre thereof is aligned with a first axis of rotation, and
a target positioned between the Fresnel lens and the focal plane thereof.

2. A solar concentrator according to claim 1, wherein the Fresnel lens is composed of a plurality of Fresnel lenses which concentrate the solar radiation respectively on a plurality of targets positioned between the Fresnel lenses and the focal planes thereof.

3. A solar concentrator according to claim 1, wherein the target is a photovoltaic cell and/or a thermal sensor or thermal or mechanical motor, or Stirling motor or chemical reaction sensor.

4. A solar concentrator according to claim 1, wherein said first axis of rotation and/or said second axis of rotation is/are actuated by a wire motor or by a remote-controlled motor.

5. A solar field, including a plurality of solar concentrators according to claim 1, the first axes of rotation of which are all parallel together and all mechanically linked by a linking rod, the movement or the rotation by a motor of which simultaneously rotates said first axes of rotation.
